(19) United States
(12) Patent Application Publication
(10) Pub. No.: US 2023/0136740 A1
(43) Pub. Date: May 4, 2023

(54) ADJUSTABLE VEHICLE RACK

(71) Applicant: Extang Corporation, Ann Arbor, MI (US)

(72) Inventor: Cameron Warech, Lawrenceville, GA (US)

(21) Appl. No.: 17/971,003

(22) Filed: Oct. 21, 2022

Related U.S. Application Data
(60) Provisional application No. 63/273,496, filed on Oct. 29, 2021.

(51) Int. Cl. B62D 33/02

(52) U.S. Cl. CPC B62D 33/0207

(57) ABSTRACT

A vehicle rack comprising: (a) a lateral member; (b) a crossmember extending transversely relative to the lateral member; and (c) a leg, wherein the lateral member, the crossmember, or both are secured to the leg; wherein the crossmember is movable along a longitudinal axis of the lateral member and the crossmember is adapted to mount to the lateral member.

### FIELD

This application claims benefit to U.S. Provisional Application No. 63/273,496, filed on Oct. 29, 2021, all of which is incorporated by reference herein in its entirety for all purposes.

### FIELD

The present teachings generally relate to a vehicle rack, and more specifically, to an adjustable vehicle rack for a vehicle bed.

### BACKGROUND

Vehicle accessories, and particularly, accessories for vehicles having a cargo box, have become increasingly prominent. Often times, vehicle having a cargo box, such as a pickup truck, will have one or more accessories fixed directly to a portion of the cargo box. The accessories may be fixed within the confines of the vehicle, may be secured along walls defining the cargo box, or both. For example, a vehicle rack may be disposed substantially across a width of the cargo box and secured along a top edge and/or an inner panel of the cargo box by one or more brackets. The rack may be positioned behind a cab of the vehicle and over the cargo box to support and/or secure one or more items. As a result, such items may be secured to the rack instead of being located within the confines of the cargo box, thereby providing additional storage capabilities for the vehicle.

Often times vehicle racks may be secured using conventional attachment mechanisms. Such attachment may often require permanent modification to the cargo box or laborious installation to install the rack to the cargo box. For example, a top edge and/or inner panel of the cargo box may often need to be permanently drilled, welded, or otherwise modified to receive and secure a vehicle rack. As a result, a vehicle may be permanently deformed if the vehicle rack is to ever be removed. Similarly, a user of the rack may also have difficulty installing the vehicle rack initially, thereby requiring the user to seek outside expertise, such as a mechanic. Moreover, frequently no common mounting structure may exist between various vehicles. As a result, mounting of vehicle racks may often be insecure and cause rattling or damage to the accessories mounted thereon, potentially resulting in the accessories of even the vehicle rack from disconnecting from the cargo box.

Additionally, vehicle racks may frequently be fixed in a single position along the cargo box. In such a case, a user may be unable to modify or otherwise adjust the rack to provide additional customization for securing accessories. Similarly, conventional vehicle racks may often require complex or non-planar structures between various members of the rack. As a result, accessories may frequently not fit or be properly secured to a plurality of mounting points along the rack.

Therefore, there remains a need for a vehicle rack that provides an optimized means for assembly. What is needed is a vehicle rack that easily mounts to one or more features of the cargo box free of laborious assembly. Additionally, there remains a need for a vehicle rack that requires minimal or no fabrication of the vehicle cargo box for installation that may permanently deform portions of the cargo box. As such, what is needed is a vehicle rack that may mount to one or more existing features of the cargo box free of fabrication. Moreover, what is needed is a vehicle rack that provides improved customization and/or adjustability. Thus, what is needed is a vehicle rack having one or more adjustable members to adapt to various accessories being secured to the vehicle rack.

### SUMMARY

The present teachings meet one or more of the present needs by providing a vehicle rack comprising: (a) a lateral member; (b) a crossmember extending transversely relative to the lateral member; and (c) a leg, wherein the lateral member, the crossmember, or both are secured to the leg; wherein the crossmember is movable along a longitudinal axis of the lateral member and the crossmember is adapted to mount to the lateral member.

The lateral member may include a first channel and the crossmember may be secured to the first channel of the lateral member. The crossmember may include a mounting plate positioned between an end cap of the crossmember and the first channel of the lateral member to secure the crossmember.

Additionally, the vehicle rack may include a panel mounted to the lateral member, and the panel may be configured to secure an accessory. The panel may include a mounting opening to secure the panel to a second channel of the lateral member via a fastener. The panel may include a first flange that abuts the lateral member, and the fastener may extend through a mounting hole of the first flange to secure the panel to a second channel of the lateral member. The first channel may be located on a first face of the lateral member and the second channel may be located on a second face of the lateral member, and the first face and the second face may be nonplanar. The panel may include a plurality of openings to secure the accessory. The panel may include a second flange that abuts a flange of an adjacent panel to secure the panels to each other.

Moreover, the leg may include a cover that at least partially encloses an inner cavity of the leg. One or more fasteners may extend through a surface of the inner cavity to secure the lateral member, the crossmember, or both. The leg may include a base adapted to mount the vehicle rack to a cargo box of a vehicle. The lateral member, the crossmember, or both may each include interconnected faces, and at least a portion of the interconnected faces may include a channel therein. The channel may include opposing flanges that extend inward towards one another. The lateral member, the crossmember, or both may include a cavity extending at least partially along a length of the lateral member, the crossmember, or both. The cavity may include a boss adapted to receive a fastener.

Additionally, the vehicle rack may include a mounting plate that is connected to the leg by a bolt. The vehicle rack may be secured to a cargo box of a vehicle by positioning the mounting plate within a stake pocket of the cargo box and positioning an upper surface of the cargo box between the leg of the vehicle rack and the mounting plate. The mounting plate may include a notch that receives a lip of the stake pocket. Moreover, the upper surface of the cargo box may be compressible secured between the leg and the mounting plate by tightening the bolt extending between the mounting plate and the leg.

Furthermore, the present teachings may also meet the present needs by providing a vehicle rack that: provides an optimized means for assembly; easily mounts to one or more features of the cargo box free of laborious assembly; requires minimal or no fabrication of the vehicle cargo box for installation that may permanently deform portions of the cargo box; mounts to one or more existing features of the cargo box free of fabrication; provides improved customization and/or adjustability; includes one or more adjustable members to adapt to various accessories being secured to the vehicle rack; or a combination thereof.

### BRIEF DESCRIPTION OF THE DRAWINGS

FIG. 1 is a perspective view of a vehicle rack in accordance with the present teachings.

FIG. 2A is a perspective view of a vehicle rack having crossmembers in a first position.

FIG. 2B is a perspective view of the vehicle rack of FIG. 2B having the crossmembers in a second position.

FIG. 3 is close-up view 3 of the vehicle rack of FIG. 2A.

FIG. 4 is a perspective view of the profile of a lateral member or crossmember of a vehicle rack in accordance with the present teachings.

FIG. 5 is an end view of the profile of FIG. 4.

FIG. 6 is a close-up view of a vehicle rack panel in accordance with the present teachings.

FIG. 7 is a close-up perspective view of a vehicle rack in accordance with the present teachings.

FIG. 8 is a perspective view of a vehicle rack secured to a cargo box of a vehicle.

FIG. 9 is a close-up view of a leg of a vehicle rack secured within a stake pocket of a cargo box.

FIG. 10 is a perspective view of a vehicle rack in accordance with the present teachings.

FIG. 11 is a close-up perspective view of a vehicle rack in accordance with the present teachings.

FIG. 12 is a close-up perspective view of a vehicle rack in accordance with the present teachings.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference herein in their entirety for all purposes. Other combinations are also possible as will be gleaned from the following claims, which are also hereby incorporated by reference in their entirety into this written description.

The teachings herein generally relate to a vehicle and a system for a vehicle. The vehicle may be any type of automobile, such as a car, truck, SUV, commercial vehicle, or a combination thereof. The vehicle may include a system integrating one or more accessories into the vehicle. The accessories may be assembly as part of the vehicle by the Original Equipment Manufacturer (OEM), may be provided as a secondary aftermarket component, or a combination thereof. The components may include one or more lights, one or more latches, one or more mechanical disconnects, one or more actuators, one or more mirrors, one or more doors, one or more interior components, one or more exterior components, or a combination thereof.

The components may be located near or along a cargo box of the vehicle. The cargo box may be defined as a storage portion of the vehicle adjacent to a cabin of the vehicle. The cargo box may be partially enclosed, fully enclosed, or both. The cargo box may include one or more openings, one or more doors, or a combination thereof. The cargo box may be formed from one or more side rails, one or more fenders, one or more panels, or a combination thereof. The side rails may extend parallel to each other and may be further enclosed by the fenders, panels, or both.

The cargo box may include a tailgate. The tailgate may function to at least partially enclose the cargo box. The tailgate may function as an access point into the cargo box. The tailgate may be considered a component or accessory of the cargo box. The tailgate may be moveable between an open position and a closed position. The open position may be when the tailgate is substantially parallel to the ground and provides an open access point into the cargo box. The closed position may be when the tailgate is substantially perpendicular to the ground and substantially encloses at least a portion of the cargo box. The tailgate may also move and/or be secured in one or more positions between the open position and the closed position. The tailgate may be manually operated by a user or may be actuated by one or more powered actuators. The tailgate may operate with physical user interaction or may be actuated remotely.

The tailgate and/or cargo box may be used in conjunction with a vehicle rack. The vehicle rack may function to secure one or more accessories or items to the vehicle. The one or more accessories may be construction equipment (e.g., tools, supplies, etc.), recreational equipment (e.g., kayaks, bicycles, canoes, etc.), other equipment, or a combination thereof. The vehicle rack may be disposed along any portion of the vehicle, such as a vehicle roof. However, it is envisioned that the vehicle rack may be particularly well-suited for mounting to a cargo box of a vehicle. As such, the vehicle rack may beneficially allow a user full use of the both the vehicle rack and the cargo box when mounted. Similarly, the vehicle rack may be used in conjunction with one or more accessories or components of the cargo box. For example, a tonneau cover disposed over the cargo box may be fully operation due to sufficient clearance provided by the vehicle rack mounted to the cargo box.

As discussed in further detail below, the vehicle rack may be mounted to any portion of the cargo box. The vehicle rack may be mounted to the fenders, a bulkhead of the cargo box, the tailgate, a floor panel of the cargo box, inner panels of the cargo box, or a combination thereof. However, to facilitate ease of installation, the vehicle rack may rest along an upper edge or lip of the cargo box and be installed through the upper edge or lip. For example, a bed cap may be integrated into or otherwise disposed along the upper edge of the cargo box, and the vehicle rack may rest along the bed cap. Similarly, the vehicle rack may be secured directly through the bed caps, thereby minimizing or eliminating modification of the cargo box for installation.

The vehicle rack may include a lateral member. The lateral member may function as a structural support of the vehicle rack. The lateral member may provide a mounting structure to secure one or more accessories. The lateral member may be oriented or otherwise positioned in any desired position along the rack. However, it is envisioned that the lateral member may extend lengthwise along or near a longitudinal axis of the bed caps of the cargo box, a longitudinal axis of the fender or upper portion of the cargo box, or both. The lateral members may be integrally (i.e., monolithically) formed. For example, the lateral members may be extruded, pultruded, stamped, or molded to define a profile of the lateral members. As a result, the lateral members may be solid or hollow (e.g., includes one or more cavities or one or more chambers therein).

The lateral member may comprise one or more faces. The faces may substantially form an overall structure of the lateral member. The faces may form a cavity extending through all or a portion of the lateral member. The faces may be any desired size and/or shape. Similarly, the faces may be positioned at any desired angle relative to one another. Thus, it may be gleaned from the present teachings that an overall profile of the lateral member may be defined by the faces and may be formed into any desired profile.

One or more of the faces may include a channel. The channel may function to secure one or more crossmembers of the vehicle rack. The channel may similarly function to secure one or more accessories to the lateral member and thus the vehicle rack. The channel may include an opening to receive one or more connection features of a crossmember, an accessory, or both. For example, the channel may receive a fastener, block, plate, clip, other mechanical connection means, or a combination thereof to secure the crossmember, the accessory, or both.

The channel may extend along a length of the face and/or a length of the lateral member. The channel may extend along a partial distance of the face and/or the lateral member. The channel may be substantially linear or may include one or more arcuate portions or undulations. The channel may terminate at opposing terminal ends (e.g., end caps) of the lateral member or the face or may terminate somewhere therebetween. Termination of the opening may include an opening along the end caps to receive a portion of a connection means within the channel. Conversely, the channel may instead be closed or otherwise capped.

One or more of the channels may include an opening along the channel to receive a portion of the crossmember, the accessory, a mechanical attachment means thereof, or a combination thereof. The opening may define a width of the channel as measured substantially perpendicular to a length of the channel. However, the opening may also be wider or narrower than a width of the channel. For example, the opening may include one or more inwardly turned flanges extending toward a central portion of the channel, thereby narrowing the opening of the channel to a width less than a width of the channel.

Each face may include a channel, or some faces may be free of any channel. Similarly, one or more faces may each include a plurality of channels. For example, a face may include two or more channels, three or more channels, or four or more channels. A face may include six or less channels, five or less channels, or four or less channels. Thus, configurations of the lateral members may vary based upon a given application.

It is envisioned that the lateral members may also include a mounting means. The lateral members may be mounted or secured to another portion of the vehicle rack by a boss. The boss may function to receive a fastener extending from and/or through another portion of the vehicle rack. The boss may receive and secure the fastener to join the lateral member to an additional portion of the vehicle rack. The boss may be positioned anywhere along the lateral members. However, it may be particularly beneficial to position the boss within a cavity of the lateral member, thereby ensuring the faces and/or channels of the lateral member remain unobstructed. As such, a boss may include an open end located near an end cap of the lateral member to receive the fastener. Thus, the boss may extend along an entire length or a partial length of the lateral member. The boss may secure the lateral member to an additional component of the vehicle rack, such as a leg.

The leg may function to secure the vehicle rack to a vehicle. The leg may secure the vehicle rack to a cargo box of a vehicle. The leg may secure the vehicle rack to a roof of the vehicle. A plurality of legs may be positioned along the vehicle rack to provide additional securement points of the vehicle rack, thereby improving the structural rigidity. The leg may be positioned near a corner of the vehicle rack or may be positioned anywhere between corners (e.g., near a midpoint of the vehicle rack). The leg may extend transversely relative to the lateral member. For example, the lateral member may be substantially parallel to an upper surface of a fender of a vehicle while the leg extends substantially orthogonally to the lateral member towards the upper surface of the fender. As such, the leg may provide a contact point between the vehicle rack and a portion of the vehicle.

The leg may beneficially provide an easier and less-intrusive means for securing a vehicle rack when compared to a conventional vehicle rack mounting structure. That is, the legs may provide mounting of the vehicle rack free of fabrication or permanent deformation of the vehicle, such as by fabricating or deforming a cargo box of the vehicle. Such deformation and/or fabrication may include, but is not limited to, welding, cutting, melting, bending, adhering, tearing, or a combination thereof a portion of the vehicle, including a cargo box of the vehicle.

To facilitate such installation, the leg may work in conjunction with a mounting plate. The mounting plate may function to communicate with the leg to secure the vehicle rack to a vehicle. The mounting plate may at least partially exhibit a compression force on the vehicle when the vehicle rack is mounted. For example, the mounting plate in conjunction with the leg may compressibly sandwich an upper portion of a cargo box of a vehicle between the mounting plate and the leg.

To create such attachment, the mounting plate may be adapted for positioning within a stake pocket of a vehicle. The stake pocket may include an opening along an upper portion of the cargo box, such as along an upper edge of a fender through or beneath a bedcap of the cargo box. Beneficially, the mounting plate may be inserted into the stake pocket through an existing opening of the stake pocket yet be oriented once inserted into the stake pocket to abut a region around the opening of the stake pocket. That is, the mounting plate may advantageously be oversized relative to the opening of the stake pocket to press against a surface of the stake pocket after installation of the vehicle rack.

The mounting plate may also include one or more notches along an outer perimeter of the mounting plate. The notches may function to engage one or more lips of the stake pocket. The lips may be any inwardly turned portion of the stake pocket near or adjacent to the opening of the stake pocket. Such lips may be created during manufacturing of the stake pocket. For example, a stamping or piercing process my create the opening of the stake pocket, thereby deflecting portions of the material into the stake pocket near or around the opening of the stake pocket. As a result, such lips may extend at least partially within the notches of the mounting plate to prevent rotation of the mounting plate during and/or after installation of the vehicle rack.

To mount the vehicle rack, the mounting plate may be used in conjunction with a base of the leg to compress opposing sides of the surface around the opening of the mounting pocket. The base of the leg may rest or otherwise abut a portion of an outer surface of the upper surface of the fender (e.g., along a bed cap) while the mounting plate abuts an inner surface around the opening of the stake pocket. Once the stake pocket and the base of the leg are substantially coaxial or otherwise aligned, a bolt extending from the mounting plate, through the base, and into the leg may be tightened to create the compression force, thereby securing the vehicle rack. The bolt may extend into a cavity of the leg through a hole, aperture, slot, or a combination thereof of the leg. Once received, a nut or other tightening mechanism may tighten the bolt to secure the vehicle rack.

The vehicle rack may also include a crossmember. The crossmember may be positioned substantially transverse to the lateral member. That is, the lateral member may extend laterally along or near the one or more bed caps of the cargo box while the crossmember extends substantially across a width of the cargo box between opposing sides of the cargo box. The crossmember may be in communication with the lateral member. For example, the crossmember may be secured directly to the lateral member. The crossmember may be secured either directly or indirectly to the lateral member. For example, a crossmember plate secured to the crossmember (e.g., near or along an end cap of the crossmember) may connect the crossmember to the lateral member.

Advantageously, it is envisioned that the crossmember may be movably secured to the lateral member. Due to the channels along the lateral member, the crossmember may be secured to the channels yet may be guided along the channels to any number of positions. For example, as discussed in further detail below, the crossmember may be fastened to the channel using one or more fasteners. When the crossmember is located in a desired position, the fasteners may be tightened to secure the crossmember and maintain a position of the crossmember relative to the lateral member. However, if the crossmember were to be moved for any desired reason, the fasteners may be loosened slightly yet not removed from the channel to guide the crossmember along the channel to another desired location. It should also be noted that the crossmember may be secured to any number of channels of the same lateral member or a plurality of lateral members. Additionally, the crossmembers may also be secured to one or more legs of the vehicle rack in a static position of a crossmember is desired. Thus, it may be gleaned from the present teachings that the vehicle rack may be highly customizable.

The crossmember may also provide a means for adjusting a width of the vehicle rack. To do so, the crossmember may include one or more movable portions so that a width of the crossmember may be adjusted, thereby adjusting an overall width of the vehicle rack. In doing so, the crossmember may beneficially provide a way for the vehicle rack to mount to a variety of cargo box widths, further providing customization and/or adjustability of the vehicle rack.

The crossmember may include an inner crossmember and an outer crossmember. The inner crossmember may be at least partially positioned within the outer crossmember to allow the outer crossmember to slide along or otherwise move relative to the inner crossmember, or vice versa. The inner crossmember may be positioned within a cavity or channel of the outer crossmember so that the inner crossmember may at least partially protrude from the outer crossmember to engage and/or connect the crossmember to a lateral member, a leg of the vehicle rack, or both. As such, the communication between the inner crossmember and the outer crossmember may provide telescoping movement of the crossmember to adjust a length of the crossmember. However, it should also be noted that any number of movable pieces may make up the crossmember (i.e., two or more members, three or more members, or four or more members).

It is also important to note that the crossmember may have a profile similar to the lateral member. That is, the crossmember may include similar faces, may include one or more channels, etc., when compared to a lateral member of the vehicle rack. However, the crossmember may also have a different profile than the lateral member. Moreover, some lateral members may have a similar profile to some crossmembers while other lateral members and/or crossmembers may have a different profile. As such, it may be gleaned that any number of lateral members and/or crossmembers may be utilized in the vehicle rack based upon various applications.

The vehicle rack may also include one or more panels. The panels may function to secure an accessory to the vehicle rack. The panels may function to provide structural integrity to the vehicle rack. The panels may at least partially define a shape of the vehicle rack. Moreover, the panels may also be secured or positioned anywhere along the vehicle rack. For example, the panels may be secured to one or more lateral members, one or more crossmembers, or both. Additionally, the panels may be adapted to connect to each other.

The panels may include one or more flanges. The flanges may function to communicate with the crossmember, the lateral member, other flanges of additional panels, or a combination thereof. The flanges may extend from a face of the panel at any desired angle to mate and/or abut with the crossmember, the lateral member, other flanges of additional panels, or a combination thereof. The face of the panel may be defined as a surface engaging and/or securing an accessory to the panel and/or the vehicle rack.

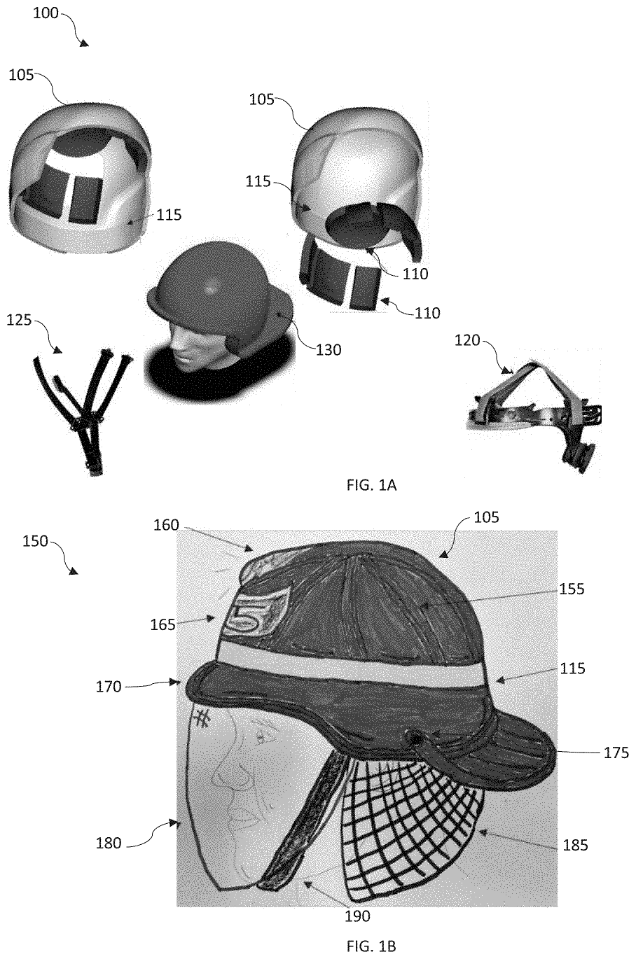

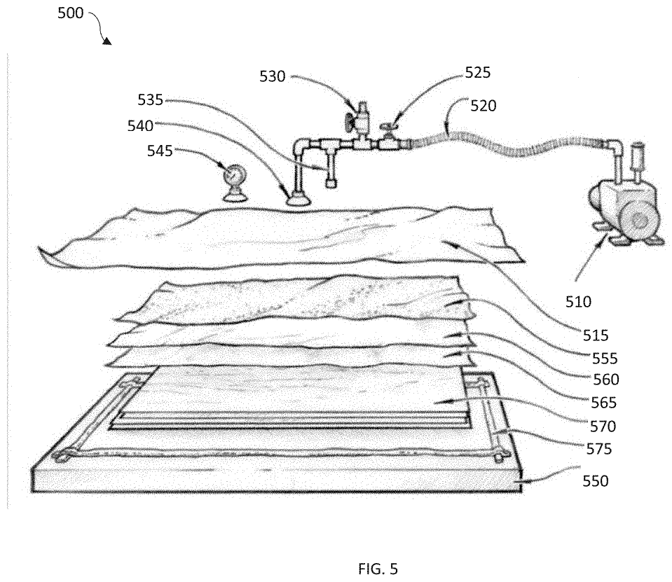

Turning now to the figures, FIG. 1 illustrates a perspective view of a vehicle rack 30 in accordance with the present teachings. The vehicle rack 30 may include opposing lateral members 32. The lateral members 32 may be configured to extend along a length of a cargo box of a vehicle (see FIG. 8). That is, the lateral members 32 may extend along a longitudinal axis of a bed cap or upper edge of the cargo box. As such, the lateral members 32 may have a longitudinal axis parallel to a longitudinal axis of the bed cap or upper edge of the cargo box.

The vehicle rack 30 may also include a pair of crossmembers 34. The crossmembers 34 may extend transversely relative to one or more of the lateral members 32. Thus, the crossmembers 34 in communication with the lateral members 32 may substantially form a frame of the vehicle rack 30, thereby at least partially defining an overall shape of the vehicle rack 30.

The lateral members 32, the crossmembers 34, or both may be secured to one or more legs 36 of the vehicle rack 30. The legs 36 may be positioned at or near corners of the vehicle rack 30. However, it is envisioned that the legs 36 may be positioned anywhere along the vehicle rack 30 to communicate with a portion of the vehicle (e.g., the cargo box) to secure the vehicle rack 30 to the vehicle. As further discussed below, the legs 36 may receive a portion of the lateral members 32 and/or the crossmembers 34 to secure the lateral members 32 and/or the crossmembers 34 using one or more fasteners. For example, as shown in FIG. 1, each leg may receive a plurality of lateral members 32, one or more crossmembers 34, or a combination thereof. Thus, it may be gleaned from the present teachings that the vehicle rack 30 may provide a variety of configurations to meet packaging constraints or requirements.

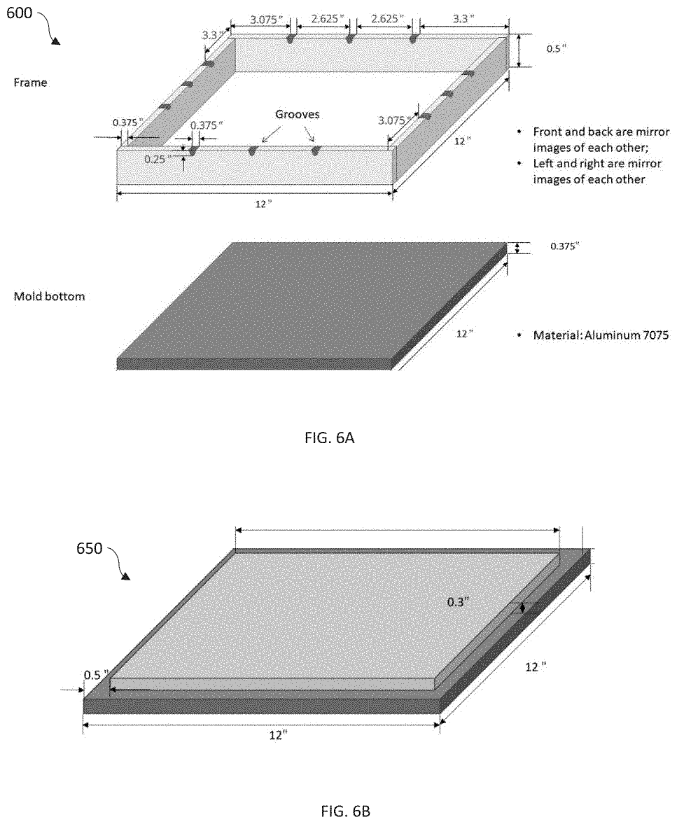

To secure the vehicle rack 30 to a vehicle (e.g., a cargo box of the vehicle), one or more of the legs 36 may include a base 38. The base 38 may provide a mounting surface that contacts a portion of the vehicle, such as an upper surface (e.g., a bed cap) of an outer edge of the cargo box of the vehicle (see FIGS. 8 and 9). While each leg 36 is shown having a base 38, it is envisioned that one or more of the legs 36 may also be free of a base 38 or may include an additional mounting feature when needed.

The vehicle rack 30 may be adapted to secure one or more accessories to a vehicle. For example, one or more accessories may beneficially be secured to the lateral members 32, the crossmembers 34, or both. Similarly, one or more accessories may be secured to a panel 42 of the vehicle rack 30. As shown, a plurality of panels 42 may between and/or along adjacent lateral members 32 to form a network of panels 42. As discussed in further detail below, the panels 42 may include mounting features to secure the panels 42 to the lateral members 32 along with attachment features to secure one or more accessories to the vehicle rack 30.

The panels 42 may extend along a length of the vehicle rack 30 which may be measured along a longitudinal axis of one or more of the lateral members. Beneficially, each side of the vehicle rack 30 may include a pair of lateral members 32 positioned adjacent to and spaced apart from one another. As a result, the panels 32 may span a distance between the adjacent lateral members 32 to secure the panels 32.

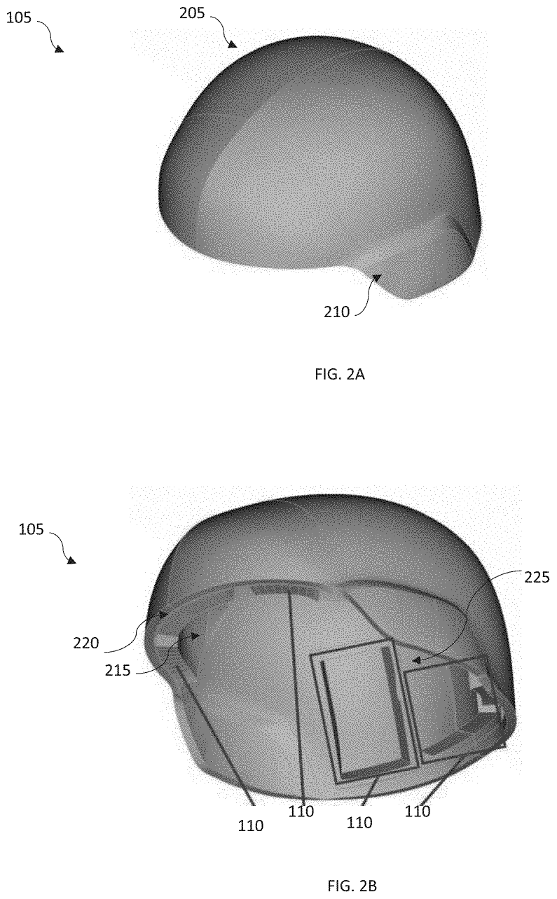

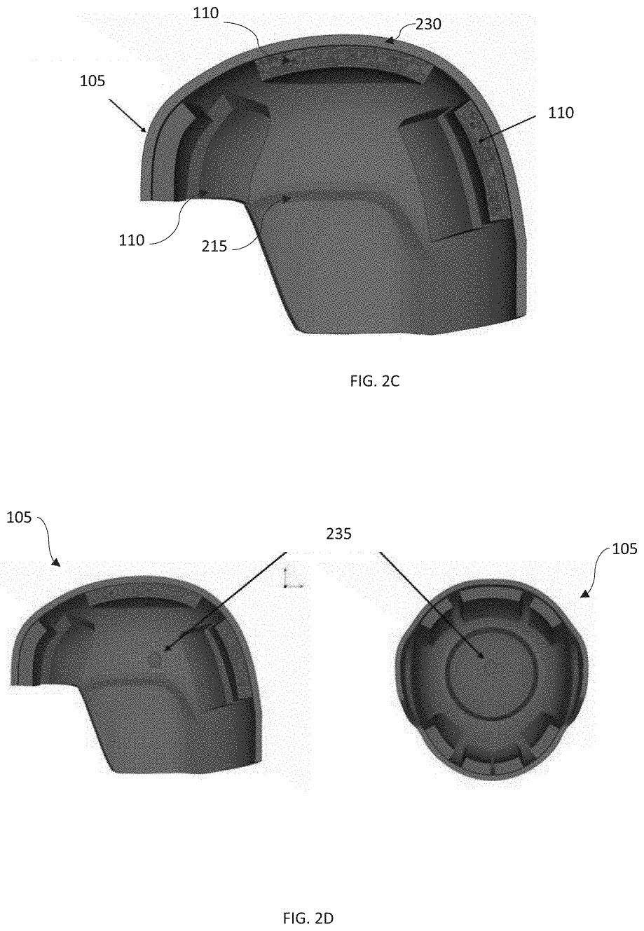

FIGS. 2A and 2B illustrate a perspective view of a vehicle 30 having crossmembers 34 in a first position and a second position, respectively.

As shown in FIG. 2A, the vehicle rack 30 may include opposing lateral members 32 adapted to span along opposing sides of a cargo box of a vehicle. The lateral members 32 may extend between legs 36 of the vehicle rack 30. The crossmembers 34 may extend substantially transverse to the lateral members 32 to define a substantially box-like structure. However, it should be noted that any desired shape of the vehicle rack 30 may be configured.

The crossmembers 34 may be secured to the legs 36 of the vehicle rack 30 in a similar fashion. However, the crossmembers 34 may also advantageously be secured to the lateral members 32 themselves. As discussed in further detail below, the crossmembers 34 may extend between opposing lateral members 32 so that opposing end caps of the crossmembers 34 may be secured to the opposing lateral members 32, thereby forming an overall shape or frame of the vehicle rack 30.

Additionally, it should be noted that, when compared to the vehicle rack shown in FIG. 1, the vehicle rack 30 may include any desired number of lateral members 32, crossmembers 34, or both. For example, the vehicle rack 30 as shown in FIG. 1 may include a pair of lateral members 32 on each side of the vehicle rack 30 to secure an upper and lower portion of each panel 42. Conversely, the vehicle rack 30 shown in FIGS. 2A and 2B may include a single lateral member 32 on each side of the vehicle rack 30, whereby a plurality of panels 42 are interconnected and secured to a single lateral member 32, one or more legs 36, or both.

As discussed above, the vehicle rack 30 may be secured to a vehicle—or a cargo box thereof—by mounting bases 38 of each leg to the vehicle. Once mounted, a user may secure one or more accessories to the vehicle rack for transportation. Beneficially, as may be seen in FIGS. 2A and 2B, the lateral members 32 and the crossmembers 34 may form a substantially planar top surface of the vehicle rack 30. Thus, a user may advantageously secure any number of accessories along the top surface of the vehicle rack 30 using the lateral members 32, the crossmembers 34, or both. As such, accessory mounting may not be constrained to a span between the crossmembers 34, the lateral members 32, or both. That is, the accessories being mounting along the top surface of the vehicle rack may extend beyond an outer perimeter as defined by the lateral members 32 and crossmembers 34 while still being secured in a substantially level position due to the substantially planar surface formed by the lateral members 32 and the crossmembers 34.

To further accommodate mounting accessories to the vehicle rack 30, the crossmembers 34 may be movably mounted to the lateral members 32. As discussed in further detail below, the lateral members 32 may include one or more channels that secure the crossmembers 34. As a result, the crossmembers 34 may maintain a substantially transverse position relative to the lateral members 32 yet be moved along the channels of the lateral members 32. That is, the crossmembers 34 may be moved along all or a portion of the length of the lateral members 32.

For example, as shown in FIG. 2A, the crossmembers 34 may be located in a first position near opposing ends of the lateral members 32. The crossmembers 34 may be secured within channels of the lateral members 32 or may be secured to the legs 36 of the vehicle rack 30 (see FIG. 1). However, if a user wishes to adjust the position of the crossmembers 34, the crossmembers may be moved in a direction (D) along the lateral members 32 to any desired position. As shown in FIG. 2B, the crossmembers 34 may be moved in the direction (D) to reach a second position positioned nearer a midpoint along the length of the lateral members 32. Thus, it may be gleaned from the present teachings that a user may position the crossmembers 34 in any number of locations while the vehicle rack 30 remains structurally intact.

As shown in FIG. 2B, the crossmembers 34 may be guided along the lateral members 32 by crossmember plates 50. The crossmember plates 50 may be secured to end caps of the crossmembers 34 to mate or otherwise communicate with the lateral members 32. As such, the crossmember plates 50 may beneficially at least partially guide the crossmembers 34 along the lateral members 32.

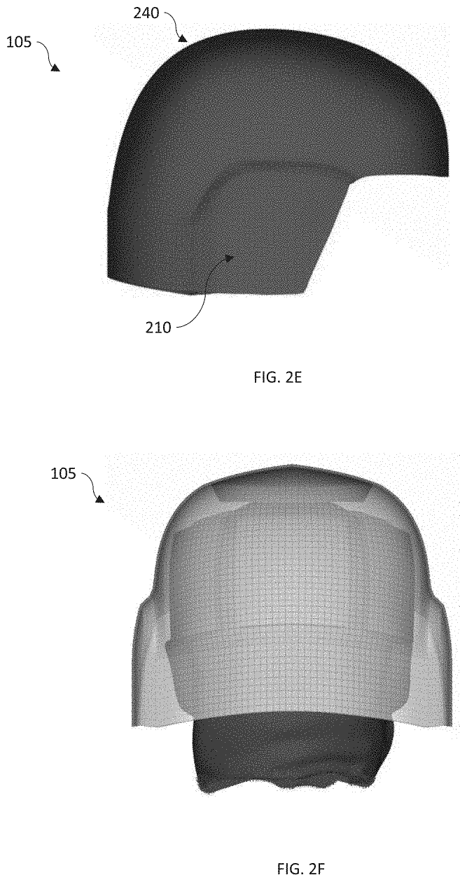

FIG. 3 illustrates close-up view 3 of the vehicle rack 30 of FIG. 2A. As discussed above, the vehicle rack 30 may include a crossmember 34 transversely positioned relative to a lateral member 32 of the vehicle rack 30. While the crossmember 34 may be secured to the lateral member 32, the crossmember 34 and the lateral member 32 may both be secured to a leg 36 of the vehicle rack 30 by a plurality of fasteners 82 extending from an inner housing of the leg 36.

The leg 36 may also include a cover 40. The cover 40 may be disposed over the leg 36 and secured to the leg 36 by one or more cover fasteners 84 so that the cover 40 at least partially encloses the housing of the leg 36. As such, a user may beneficially remove the cover 40 when disassembly or movement of one or more lateral members 32, crossmembers 34, or both is desired. Similarly, the cover 40 may provide protection to the fasteners 82, 84 or any other component located within the housing of the leg 36 by preventing moisture and/or debris from degrading the fasteners 82, 84 or any other component within the housing.

As mentioned above, the legs 36 of the vehicle rack 30 may be secured to a vehicle or cargo box thereof using a base 38 mounted to the leg 36. The base 38 may abut or be positioned adjacent to a portion of the cargo box so that a bolt 86 may extend through the base 38 and a mounting hole 60 of the leg 36 to interconnect the leg 36 and the cargo box. As discussed in further detail below, the bolt 86 may also be secured to a mounting plate 54, thereby allowing a compressive force to be applied to a portion of the cargo box to secure the vehicle rack 30. During such mounting, a spacer 52 may also be positioned between the base 38 and the cargo box to further aid in securing the leg 36 to the cargo and/or to help maintain a desired position of the vehicle rack 30 relative to the cargo box (see FIGS. 8 and 9).

Additionally, the vehicle rack 30 may include one or more interconnected panels 42. The panels 42 may include a plurality of openings 46 to secure one or more accessories to the vehicle rack 30. Beneficially, the panels 42 may include a plurality of flanges 44 to secure the panels 42 to the lateral member 32, the leg 36, or each other.

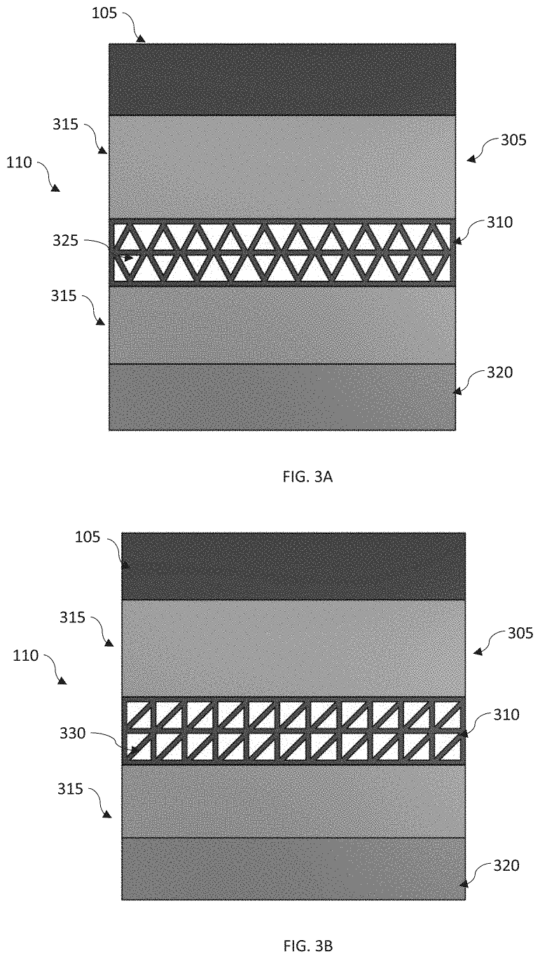

FIG. 4 is a perspective view illustrating the profile of an exemplary lateral member 32. It should be noted that the lateral members 32 and the crossmembers may have a similar or identical profile. That is, the profile as described with respect to FIG. 4 may also apply to one or more of the crossmembers described herein. However, the crossmembers may also have a different profile than the lateral members 32.

The lateral member 32 may include a plurality of interconnected faces 70 that at least partially define an overall shape of the lateral member 32. The lateral member 32 may include any number of faces 70. For example, the lateral member 32 may include one or more faces, two or more faces, or three or more faces. The lateral member 32 may include six or less faces, five or less faces, or four or less faces. Similarly, the lateral members 32 may include the same number of faces 70 or may each include a different number of faces 70.

As shown, one or more of the faces 70 may include a channel 72. As discussed above, the channel 72 may be adapted to secure the crossmember in a movable manner. A movable manner may be defined as the crossmember being adapted for securement to one or more channels 72 of the lateral member 32 to maintain a position of the crossmember yet may be adjusted to move along one or more of the channels 72 of the lateral member 32.

The channels 72 may also be configured to receive one or more accessories or mounting features thereof. For example, one or more of the channels 72 may be configured to receive a lighting strip therein, may receiving one or more mounting features of a tool, etc. As shown, the channels 72 may extend between opposing end caps 78 of the lateral member 32. However, it is also envisioned that the channels 72 may also only extend partially along a length of the lateral member 32 so that the channels 72 may terminate a position between the end caps 78.

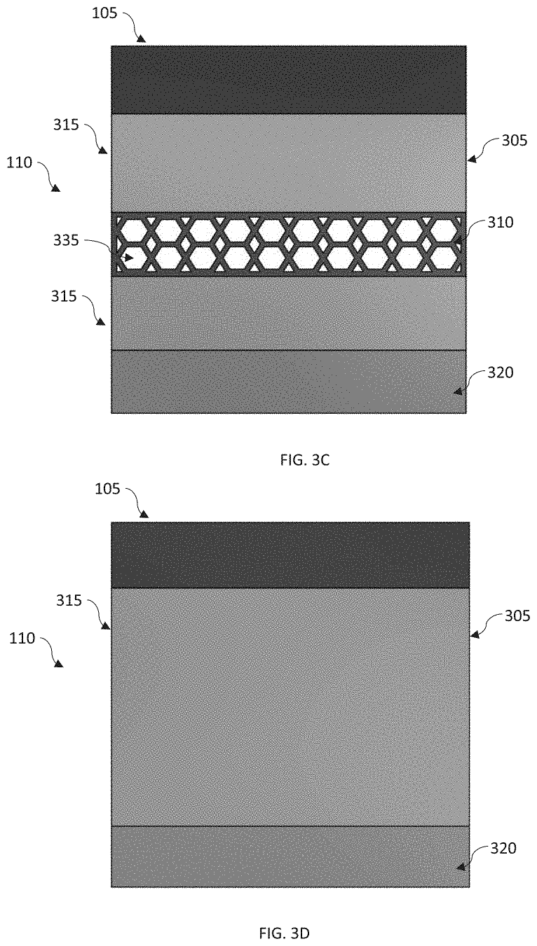

FIG. 5 illustrates an end view of the lateral member 32 of FIG. 4. As discussed above, the lateral member 32 may include a plurality of interconnected faces 70, whereby one or more of the faces 70 includes one or more channels 72. That is, a portion of the faces 70 may be free of a channel 72.

The channels 72 may vary in size and/or shape. For example, a portion of the channels 72 include a flange 74. The flanges 74 may turn inwardly toward each other to at least partially enclose an opening 72A of the channel 72, thereby forming a T-Slot. Additionally, a portion of the channels 72 may also be free of any flanges 74 to provide a larger opening into the channel 72. Thus, the lateral members 32 may beneficially provide a variety of attachment means for a user.

The plurality of faces 70 may also form a cavity 80 of the lateral member 32. The cavity 80 may extending entirely or partially along a length of the lateral member 32. The cavity 80 may include one or more bosses 76. The bosses 76 may also extend entirely or partially along a length of the lateral member 32 within the cavity 80. The bosses 76 may be adapted to receive one or more fasteners. For example, when the lateral member 32 is secured to a leg of the vehicle rack, the fasteners may extend through an inner surface of the leg and into the bosses 76. Thus, the lateral member 32 may be secured to the leg without encumbrance on the channels 72 of the lateral member 32.

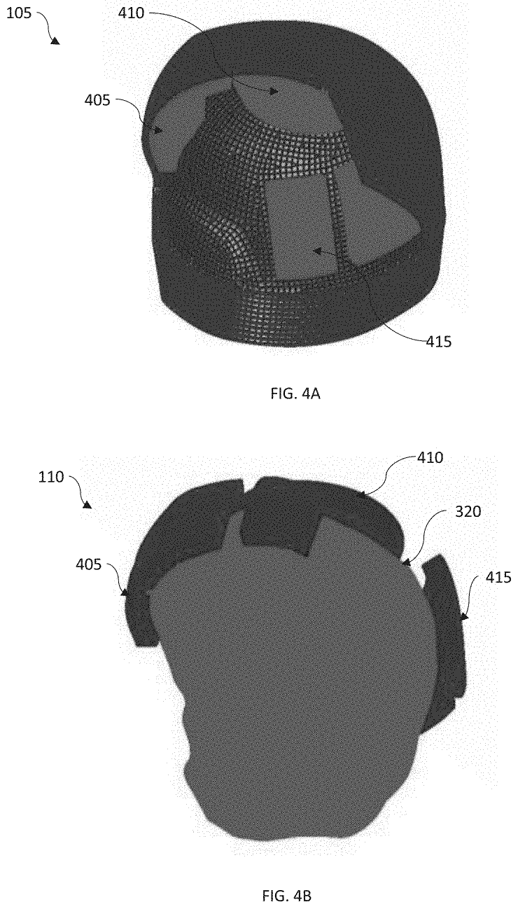

FIG. 6 is a close-up view of a panel 42 of a vehicle rack in accordance with the present teachings. As discussed above, one or more panels 42 may be secured along the vehicle rack. As shown, the panel 42 may extend between a pair of lateral members 32 to secure the panel 42 to the lateral members 32. For example, one or more fasteners may extend through mounting openings 46A along the panel 42 that align with a portion of each lateral member 32 (e.g., a channel of the lateral member 32). The mounting openings 46A may be a hole, aperture, slot, or other opening to facilitate securing the panel 42 to one or more lateral members 32. It should also be noted that such panels 42 may also be secured to one or more crossmembers in a similar fashion. Additionally, the panel 42 may include a plurality of openings 46 adapted to secure one or more accessories to the vehicle rack. The openings may vary in size and/or shape, may include one or more cutouts, one or more slots, one or more circular holes, one or more rectangular openings, etc. Thus, the panels 42 may advantageously allow for various attachment means for one or more accessories, thereby even further allowing for customization of the vehicle rack.

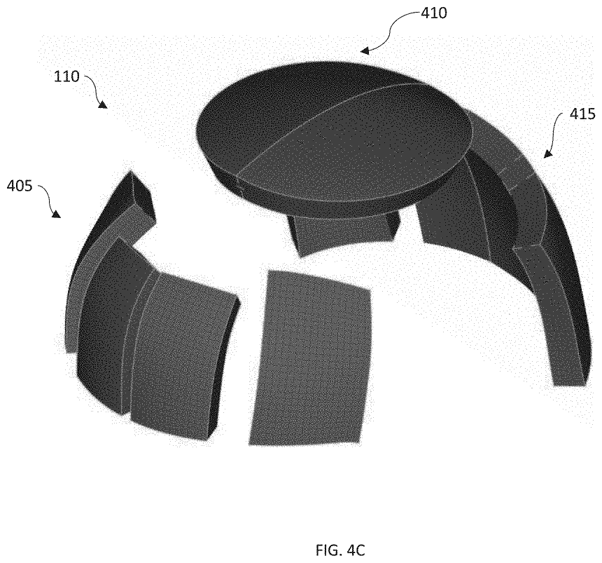

FIG. 7 is a close-up perspective view of a portion of a vehicle rack as discussed herein. As mentioned above, the vehicle rack may include one or more crossmembers 34 secured to a lateral member 32 using a crossmember plate 50. The lateral members 32 may be secured to one or more legs 36 of the vehicle rack to mount the vehicle rack to a vehicle. Additionally, flanges 44 of the one or more panels 42 may abut a face of the lateral member 32 to secure the panels 42 to the lateral member 32 using one or more fasteners (not shown) extending through mounting holes 48 of the panels 42. Similarly, additional flanges 44 of the panels 42 may abut one another so that mounting holes 48 of the panels align with each to receive a fastener therethrough, thereby securing the panels 42 to each other. In a similar manner, flanges 44 of the panels 42 may abut the leg 36 so that a fastener 82 may extend through the leg 36 and into a mounting hole 48 of the panel 42.

FIG. 8 is a perspective view of a vehicle rack 30. As discussed above, the vehicle rack 30 may include a plurality of lateral members 32 and crossmembers 34 that form at least a portion of the overall structure. The lateral members 32 and/or crossmembers 34 may be secured to legs 36 of the vehicle rack 30. Panels 42 may be disposed along one or more sides of the vehicle rack 30 and secured to the lateral members 32, the crossmembers 34, the legs, 36, or a combination thereof.

As shown, the vehicle rack 30 may be mounted to a cargo box 20 of a vehicle. The vehicle has been omitted from the drawing for simplicity. The cargo box 20 may be defined by a plurality of fenders 21 positioned on opposing sides of a tailgate 22. A bulkhead (not shown) may also form an additional panel of the cargo box 20 to create a storage area within the cargo box 20. To allow for full use of the cargo box 20, the vehicle rack 30 may beneficially be mounted along an upper edge of the fenders 21. However, it should be noted that other mounting positioning may also be possible, such as mounting directly to the fenders 21 or an inner panel thereof, mounting to the tailgate 22, mounting to a bulkhead, or a combination thereof.

To secure the vehicle rack 30, the legs 36 or a base thereof (see, e.g., FIG. 3) may be located on the upper edge of the fenders 21. For example, the cargo box 20 may include bed caps 24 along the upper portion of the fenders 21. The bed caps 24 may thus support the legs 36 or a base of the legs. As a result, a mounting feature may extend through the bed caps 24 and into stake pockets 26 located beneath the bed caps 24 (see FIG. 9). Thus, the vehicle rack 30 may advantageously allow for mounting free of fabrication of the cargo box 20 or permanent deformation. That is, a user may simply remove a cap or a small portion of the bed cap 24 positioned above the stake pockets 26 so that the mounting features of the vehicle rack 30 are received by the stake pockets 26 and the legs 36 of the vehicle rack 30 are at least partially positioned over the stake pockets 26.

FIG. 9 illustrates a close-up view of a leg 36 of the vehicle rack of FIG. 8. As discussed above, the leg 36 may be positioned to at least partially align with a stake pocket 26 of the cargo box. A base 38 of the leg 36 may abut an upper surface of the bed cap 24. Additionally, a spacer 52 may be positioned between the base 38 and the upper surface of the bed cap 24 to determine a desired height of the vehicle rack 30. For example, the bed caps 24 may have an uneven upper surface with one or more undulations, ribs, beads, etc. As such, the spacer 52 along with the base 38 may ensure the vehicle rack is mounted in a level manner relative to the cargo box, the ground, or both, thereby maintaining the substantially planar upper surface of the vehicle rack 30 for mounting one or more accessories.

To secure the leg 36 of the vehicle rack 30, a mounting plate 54 may be positioned within the stake pocket 26 to abut an inner side of the upper surface of the bed cap 24, fender 21, or other portion of the cargo box 20. A bolt 86 may extend through the mounting plate 54 and into the leg 36 of the vehicle rack 30 so that the bolt may be tightened within a cavity of the leg 36 (see FIG. 3). As a result, a compression force may be exhibited on the bed cap 24 and/or upper surface of the cargo box 20 so that the bed cap 24 and/or upper surface of the cargo box 20 are sandwiched between the leg 36 (e.g., the base 38 and/or spacer 52) and the mounting plate 54. Additionally, the mounting plate 54 may include one or more notches 56 that align with and at least partially receiver inwardly turned lips 28 of the stake pocket 26. As a result, the mounting plate is prevented from unwanted rotation during installation of the vehicle rack 30. Similarly, such mounting structure may beneficially allow a user to install the vehicle rack 30 in a simple and efficient manner without any fabrication of the cargo box.

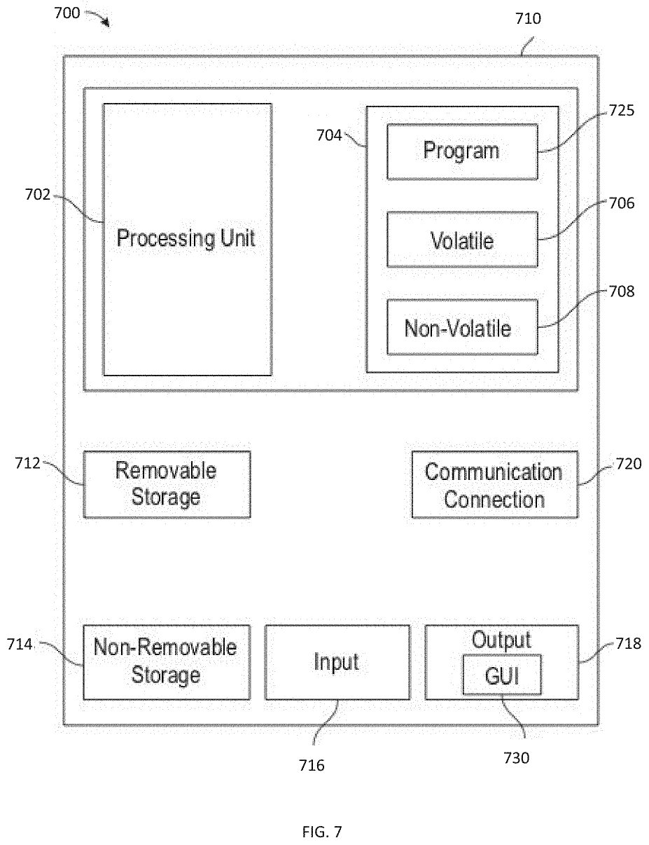

FIG. 10 illustrates a perspective view of a vehicle rack 30 in accordance with the present teachings. The vehicle rack 30 may include opposing lateral members 32. The lateral members 32 may be configured to extend along a length of a cargo box of a vehicle (see, e.g., FIG. 8). That is, the lateral members 32 may extend along a longitudinal axis of a bed cap or upper edge of the cargo box.

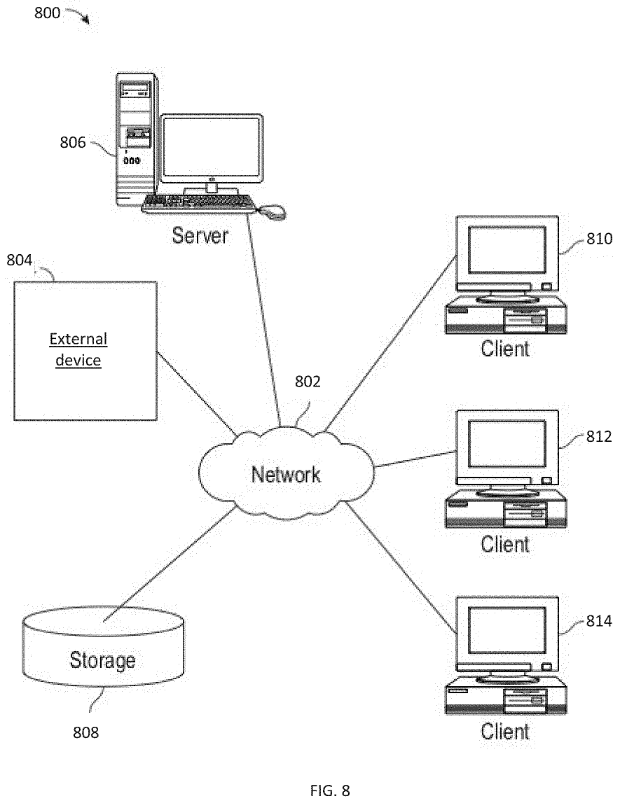

The vehicle rack 30 may also include a pair of crossmembers 34. The crossmembers 34 may extend transversely relative to the lateral members 32 to at least partially form a perimeter of the vehicle rack 30. Advantageously, the crossmembers 34 may facilitate adjustment of a width (e.g., as measured substantially along a length of the crossmembers 34 transverse to the lateral members 32) of the vehicle rack 30. To do so, the crossmembers 34 may include an inner crossmember 34A and an outer crossmember 34B in communication with one another to provide telescoping movement of the crossmember 34 (see FIG. 11). Therefore, the crossmembers 34 may telescope to adjust a width of the vehicle rack 30 for mounting to a variety of cargo box widths of a vehicle, thereby providing even further customization and/or tunability. Additionally, as detailed above, the crossmembers 34 may also be mounted anywhere along the lateral members 32 to accommodate various cargo dimensions.

The lateral members 32, the crossmembers 34, or both may be secured to one or more legs 36 of the vehicle rack 30. The legs 36 may be positioned at or near corners of the vehicle rack 30. However, it is envisioned that the legs 36 may be positioned anywhere along the vehicle rack 30 to communicate with a portion of the vehicle (e.g., the cargo box) to secure the vehicle rack 30 to the vehicle. The legs 36 may receive a portion of the lateral members 32 and/or the crossmembers 34 to secure the lateral members 32 and/or the crossmembers 34 using one or more fasteners.

To secure the vehicle rack 30 to a vehicle (e.g., a cargo box of the vehicle), one or more of the legs 36 may include a base 38. The base 38 may provide a mounting surface the abuts a portion of the vehicle, such as an upper surface of an outer edge of the cargo box of the vehicle (see, e.g., FIGS. 8 and 9). For example, the base 38 may be supports by a bed cap located along the outer edge of the cargo box.

Advantageously, mounting of the bases 38 to the cargo box may be completed in a variety of configurations based upon the vehicle being mounted to. In certain circumstances, the bases 38 may be in communication with a plate or bracket located within a stake pocket of the cargo box so that the bases 38 may be secured (e.g., fastened) to the plate or bracket to secure the bases 38 above the stake pockets. Similarly, the bases 38 may include, or be connected to, one or more brackets that mount to an inner fender or an inner lip of the cargo box to secure the vehicle rack 30 in place. Examples of various mounting schemes can be found in U.S. Pat. No. 11,034,307, all of which is incorporated herein in its entirety for all purposes.

The vehicle rack 30 may be adapted to secure one or more accessories to a vehicle. For example, one or more accessories may be secured to the lateral members 32, the crossmembers 34, or both. Similarly, one or more accessories may be secured to a panel 42 of the vehicle rack 30. As shown, a plurality of panels 42 may be located along the lateral members 32 to form a network of adjacent panels 42.

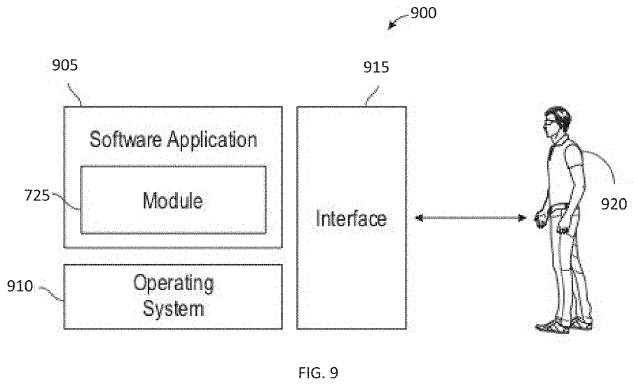

FIGS. 11 and 12 illustrate close-up perspective views of a vehicle rack 30 in accordance with the present teachings. As discussed above, the vehicle rack 30 may include a crossmember 34 transversely positioned relative to a lateral member 32 of the vehicle rack 30. The crossmember 34 may include an inner crossmember 34A in movable communication with an outer crossmember 34B so that the inner crossmember 34A and the outer crossmember 34B may move in an adjustment direction (A) relative to each other. As a result, the crossmembers 34 may advantageously adjust a width of the vehicle rack based upon a position of the outer crossmember 34B relative to the inner cross member 34A. More specifically, the inner crossmember 34A may include or be secured to a crossmember plate 50 of the crossmember 34. The crossmember plate 50 may include a plurality of crossmember plate holes 50A that facilitate mounting of the crossmember 34 to the lateral members 32. That is, the crossmember 34 may slide along a length of the lateral member 32 to various positions and be secure in place by the crossmember plate 50. Moreover, as the inner crossmember 34A is secured to the crossmember plate 50, the outer crossmember 34B may be slidably engaged to the inner crossmember 34A so that the outer crossmember 34B may move along the inner crossmember 34A. Once a desired width is selected, the outer crossmember 34B may be secured to the inner crossmember 34A by one or more fasteners extending through locking holes 88 of the crossmember 34.

While the crossmember 34 may be secured to the lateral members 32, the crossmember 34 and/or the lateral member 32 may also be secured to a leg 36 of the vehicle rack 30 by a plurality of fasteners extending through fastener holes 82A. Beneficially, the leg 36 may include a window 92 therein that facilitates access to one or more channels 72 of the crossmember 34, the lateral member 32, or both. As a result, one or more fasteners or secondary features may be slid into the channel 72 without requiring that the crossmember 34, the lateral member 32, or both be disconnected from the leg 36. For example, the channel 72 may be a t-slot that allows for one or more fasteners to be slid into the t-slot through the window 92. Additionally, the leg 36 may also include a cover 40 secured to the leg 36 by additional fasteners extending through cover fastener holes 84A along the leg 36.

The legs 36 of the vehicle rack 30 may be secured to a vehicle or cargo box thereof using a base 38 of the leg 36. The base 38 may abut or be positioned adjacent to a portion of the cargo box so that a bolt or other fastener may extend through the one or more mounting holes 60 of the base 38 and into the cargo box to secure the leg 36 to the cargo box. For example, as stated above, the base 38 may be in communication with a portion of the cargo box, one or more brackets, a stake pocket of the cargo box, or a combination thereof to secure the leg 36 to the cargo box. As such, the base 38 may be in direct communication with the cargo box or may include one or more intermediary components positioned between the base 38 and the cargo box (e.g., a spacer, plate, bracket, etc.).

Additionally, the vehicle rack 30 may include one or more interconnected panels 42. The panels 42 may include a plurality of openings 46 to secure one or more accessories to the vehicle rack 30. The panels 42 may also include a plurality of flanges 44 to mount the panels 42 to the lateral members 32, the leg 36, the crossmembers 34, or a combination thereof using fasteners that extend through mounting holes 48 of the panels 42.

### ELEMENT LIST

20 Cargo Box

21 Fender

22 Tailgate

24 Bed Cap

26 Stake Pocket

28 Lip

30 Vehicle Rack

32 Lateral Member

34 Crossmember

34A Inner Crossmember

34B Outer Crossmember

36 Leg

38 Base

40 Cover

42 Panel

44 Panel Flange

46 Panel Opening

46A Mounting Opening

48 Mounting Hole

50 Crossmember Plate

50A Crossmember Plate Hole

52 Spacer

54 Mounting Plate

56 Notch

60 Leg Mounting Hole

70 Face

72 Channel

74 Channel Flange

76 Boss

78 End Cap

80 Cavity

82 Fastener

82A Fastener Hole

84 Cover Fastener

84A Cover Fastener Hole

86 Bolt

88 Locking Hole

90 Crossmember Slot

92 Leg Window

D Direction of Movement of the Crossmember

A Adjustment Direction of the Crossmember

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Unless otherwise stated, a teaching with the term “about” or “approximately” in combination with a numerical amount encompasses a teaching of the recited amount, as well as approximations of that recited amount. By way of example, a teaching of “about 100” encompasses a teaching of 100+/−15.

The disclosures of all articles and references, including patent applications and publications, are incorporated by reference herein in their entirety for all purposes. Other combinations are also possible as will be gleaned from the following claims, which are also hereby incorporated by reference in their entirety into this written description.

What is claimed is:

1. A vehicle rack comprising:
(a) a lateral member;
(b) a crossmember extending transversely relative to the lateral member; and
(c) a leg, wherein the lateral member, the crossmember, or both are secured to the leg;
wherein the crossmember is movable along a longitudinal axis of the lateral member and the crossmember is adapted to mount to the lateral member.

2. The vehicle rack of claim 1, wherein the lateral member includes a first channel and the crossmember is secured to the first channel of the lateral member.

3. The vehicle rack of claim 2, wherein the crossmember includes a mounting plate positioned between an end cap of the crossmember and the first channel of the lateral member to secure the crossmember.

4. The vehicle rack of claim 3, wherein the vehicle rack includes a panel mounted to the lateral member, and the panel is configured to secure an accessory.

5. The vehicle rack of claim 4, wherein the panel includes a mounting opening to secure the panel to a second channel of the lateral member via a fastener.

6. The vehicle rack of claim 4, wherein the panel includes a first flange that abuts the lateral member, and the fastener extends through a mounting hole of the first flange to secure the panel to a second channel of the lateral member.

7. The vehicle rack of claim 5, wherein the first channel is located on a first face of the lateral member and the second channel is located on a second face of the lateral member, and the first face and the second face are nonplanar.

8. The vehicle rack of claim 1, wherein the leg includes a cover the at least partially encloses an inner cavity of the leg.

9. The vehicle rack of claim 8, wherein one or more fasteners extend through a surface of the inner cavity to secure the lateral member, the crossmember, or both.

10. The vehicle rack of claim 9, wherein the leg includes a base adapted to mount the vehicle rack to a cargo box of a vehicle.

11. The vehicle rack of claim 4, wherein the panel includes a plurality of openings to secure the accessory.

12. The vehicle rack of claim 6, wherein the panel includes a second flange that abuts a flange of an adjacent panel to secure the panels to each other.

13. The vehicle rack of claim 1, wherein the lateral member, the crossmember, or both each include interconnected faces, and at least a portion of the interconnected faces include a channel therein.

14. The vehicle rack of claim 13, wherein the channel includes opposing flanges that extend inward towards one another.

15. The vehicle rack of claim 13, wherein the lateral member, the crossmember, or both include a cavity extending at least partially along a length of the lateral member, the crossmember, or both.

16. The vehicle rack of claim 15, wherein the cavity includes a boss adapted to receive a fastener.

17. The vehicle rack of claim 1, wherein the vehicle rack includes a mounting plate that is connected to the leg by a bolt.

18. The vehicle rack of claim 18, wherein the vehicle rack is secured to a cargo box of a vehicle by positioning the mounting plate within a stake pocket of the cargo box and positioning an upper surface of the cargo box between the leg of the vehicle rack and the mounting plate.

19. The vehicle rack of claim 18, wherein the mounting plate includes a notch that receives a lip of the stake pocket.

20. The vehicle rack of claim 3, wherein the crossmember includes an inner crossmember positioned within a channel of an outer crossmember so that a width of the crossmember can be adjusted.
